(19) United States
(12) Patent Application Publication
(10) Pub. No.: US 2007/0131473 A1
(43) Pub. Date: Jun. 14, 2007

(54) ALL WHEEL STEERING FOR PASSENGER VEHICLE

(75) Inventors: Mats Jonasson, Partille (SE); Sigvard Olof Zetterstroem, Vaestra Froelunda (SE)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/275,101

(22) Filed: Dec. 9, 2005

(51) Int. Cl. B62D 7/00

(52) U.S. Cl. 180/408

(57) ABSTRACT

A passenger vehicle, a steering system, and a method for controlling the steering system are provided for a front wheel steering mode and an all wheel steering mode that provides parallel steering and opposed wheel steering. The front wheel steering permits both linear and rotational translation of the vehicle. The parallel all wheel steering may be utilized for linear translation of the vehicle while rotational translation is reduced for optimizing stability of the vehicle. The opposed wheel steering may be utilized for minimizing a vehicle turn radius.

### BACKGROUND OF THE INVENTION

1. Field of the Invention

The present invention relates to steering for passenger vehicles, more particularly to steering front and rear wheels of passenger vehicles.

2. Background Art

The prior art provides passenger vehicles having four or more wheels for transporting the vehicle. Typically, two of the wheels are driven, such as the front wheels or the rear wheels. Typically, the front wheels are rotationally translatable as a result of a steering direction indicated by a driver of the vehicle.

The prior art has provided passenger vehicles having front and rear steerable wheels, wherein the rear wheels are actuated to an opposite steering angle of the front wheels for minimizing a turn radius of the vehicle. Four wheel steering enhances low speed maneuverability, such as that experienced while parking.

The prior art has also provided vehicles having steerable front wheels and steerable rear wheels for parallel steering of the vehicle. An aspect of such prior art parallel steering requires the driver to concurrently control conventional steering and parallel steering of the vehicle.

One prior art vehicle had four wheel steering with a rear wheel steering rack connected to a front wheel steering rack via gears and mechanical shafts. The rear wheels turned the same way as the front wheels at small steering angles for enhanced high speed stability. At greater front wheel steering angles, the rear wheels returned back to a zero steering angle; and at even greater front wheel steering angles, the rear wheels turned to angles opposite of the front wheels to reduce a turning radius of the vehicle. Thus, the driver did not activate a steering mode and no intervention from the driver was required to select or activate a steering mode.

### SUMMARY OF THE INVENTION

A non-limiting embodiment of the present invention provides a system for parallel steering of front wheels and rear wheels of a passenger vehicle. The system provides a steering wheel for manual rotation. A sensor measures an angular orientation of the steering wheel and communicates with a controller. The controller communicates with a front wheel steering actuator for steering the front wheels. The controller also communicates with a rear wheel steering actuator for steering the rear wheels for parallel steering of the vehicle, and for aligning the rear wheels with a forward direction of the vehicle for non-parallel steering of the vehicle.

Another non-limiting embodiment of the present invention provides a method for controlling parallel steering for a passenger vehicle with a vehicle controller. The method includes receiving a steering wheel input from a manual steering mechanism. A steering mode is received for selection of a front wheel steer mode or a parallel steer mode. A steering angle is transmitted to steer front wheels of the vehicle. A steering angle is also transmitted to steer rear wheels of the vehicle. The steering angle may be zero for the rear wheels in the front wheel steer mode. The steering angle may be a function of the steering wheel input to steer the rear wheels in a parallel steer mode.

Another non-limiting embodiment of the invention is a passenger vehicle having parallel steering. The passenger vehicle has a first pair of wheels for supporting and transporting the vehicle. The first pair of wheels are each pivotal about a vertical axis for steering the vehicle. A second pair of wheels are connected to the vehicle for supporting and transporting the vehicle. The second pair of wheels are each pivotal about a vertical axis for steering the vehicle. A steering mechanism is provided for manual control of the first pair of wheels for steering of the vehicle. The steering mechanism is also in selective communication with the second pair of wheels for controlling a steering angle of the second pair of wheels. A controller communicates with a second pair of wheels for selecting a first steering mode wherein the second pair of wheels are each aligned generally parallel with a forward direction of travel of the vehicle so that the first set of wheels steer the vehicle. The controller also communicates with the second pair of wheels for selecting a second steering mode for aligning a second pair of wheels in a direction corresponding generally with a steering angle of the first set of wheels for translating the vehicle linearly with reduced rotational translation.

The above aspects, objects, embodiments, benefits and advantages of the present invention are apparent in the attached figures and in the detailed description of the embodiments of the invention below.

### BRIEF DESCRIPTION OF THE DRAWINGS

FIG. 1 is a top plan schematic view of a passenger vehicle in accordance with the present invention;

FIG. 2 is a top plan schematic view of the passenger vehicle of FIG. 1, illustrated in a first steering mode;

FIG. 3 is a top plan schematic view of the passenger vehicle of FIG. 1, illustrated in another steering mode;

FIG. 4 is a schematic representation of a system for parallel steering of a passenger vehicle in accordance with the present invention; and

FIG. 5 is a flowchart illustrating a method in accordance with the present invention.

### DESCRIPTION OF EMBODIMENTS OF THE INVENTION

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

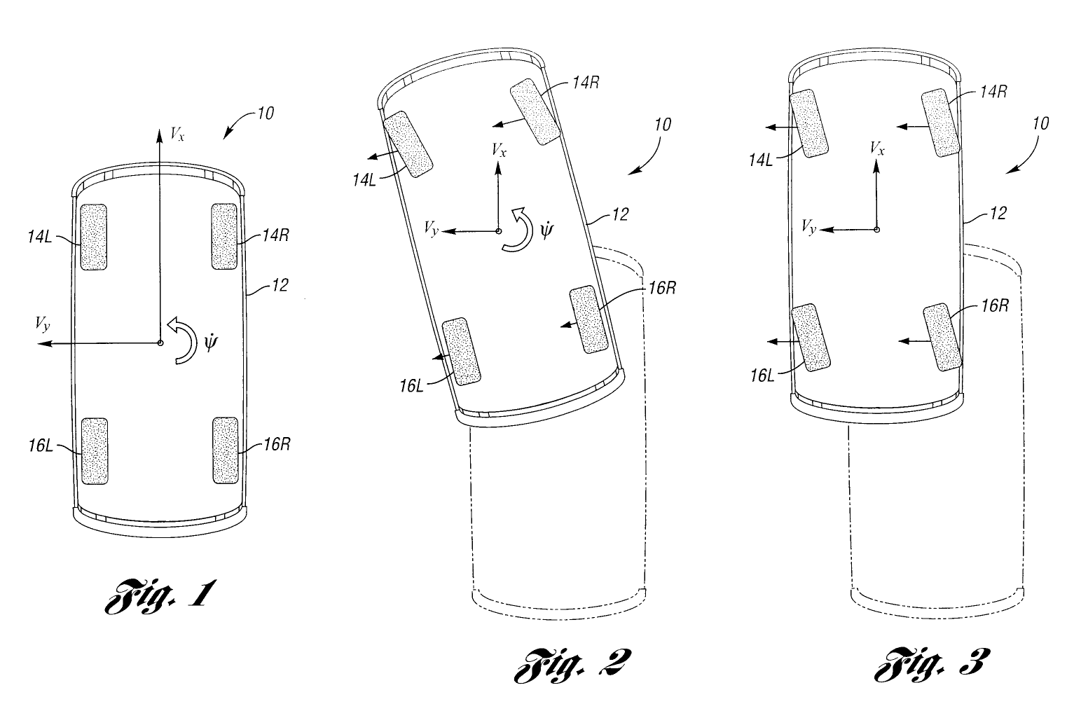

With reference now to FIG. 1, an exemplary embodiment passenger vehicle is illustrated schematically in a plan view, and referenced generally by numeral 10. The passenger vehicle 10 includes a vehicle body 12 supported upon a chassis (not shown), which is suspended upon a plurality of wheels, such as a pair of front wheels 14L, 14R and a pair of rear wheels 16L, 16R.

The front wheels 14L, 14R are each translatable relative to the body 12 for steering of the vehicle 10. Specifically, each of the front wheels 14L, 14R may be pivoted about a vertical axis for steering of the vehicle 10. The front wheels 14L, 14R may include a steering system that is interconnected for collective steering angle adjustment of the front wheels 14L, 14R. Alternatively, each of the front wheels 14L, 14R may be independently actuated for steering of the front wheels 14L, 14R. Likewise, the rear wheels 16L, 16R are steerable either collectively or independently.

For example, each of the wheels 14L, 14R, 16L, 16R may be independently steerable by steering assemblies such as those disclosed in U.S. Pat. No. 6,386,553 B2, which issued to Sigvard Zetterström on May 14, 2002, and European Patent Application No. 1 354 731 A1, which published to Sigvard Zetterström on Oct. 22, 2003. The Zetterström U.S. Pat. No. 6,386,553 B2 patent and the Zetterström EP 1 354 731 A1 patent application are incorporated in their entirety by reference herein. Likewise, the wheels 14L, 14R, 16L, 16R may also utilize the driving and suspension arrangements provided in the Zetterström U.S. Pat. No. 6,386,553 B2 patent and the Zetterström EP 1 354 731 A1 patent application.

The vehicle 10 can be observed from a local coordinate system, such as a coordinate system that is perceived by the driver. A cornering movement of the vehicle 10 is a combination of two translations, linear translation and rotational translation. When a driver turns a steering wheel on a front wheel steer vehicle, such as vehicle 10 in a front wheel steer mode, a combined translation of both linear translation and rotational translation turns the vehicle 10 in the driver-intended direction.

When steering is utilized for cornering, the direction of travel of the vehicle is altered. Steering is also utilized for parallel movement of the vehicle 10, which refers to translation of the vehicle 10 in a driving direction Vₓ and in a direction that is not parallel with the driving direction Vₓ. In other words, the parallel translation is in a direction that is a combination of linear translation in the driving direction Vₓ and a lateral direction V_{y}. Parallel translation of the vehicle, should minimize rotational translation around a vertical axis. The magnitudes of these various translations are coupled to the geometry of the vehicle 10, tire characteristics, position of the vehicles center of gravity and inertia. Rotational translation around a vertical axis generates a yaw speed \dot{ψ}.

Prior art vehicles having front wheel steering only are suitable for cornering movements of the vehicle. Prior art vehicles that are steered by two wheels only cannot be utilized for dividing parallel translation and rotational translation. When parallel movements are attempted by front wheel steer vehicles, the vehicle may skid if the yaw speed \dot{ψ} is too high for the given situation. Although a front portion of the prior art front wheel steer vehicle may avoid an obstacle, a rear portion of the front wheel steer vehicle may impact the same obstacle during an evasion maneuver. Accordingly, by providing steering to the front wheels 14L, 14R and rear wheels 16L, 16R of the vehicle 10, large lateral accelerations may be employed while minimizing vehicle yaw speed \dot{ψ}. Such parallel movements may avoid skidding of the vehicle 10 and avoid collisions with a rear part of the vehicle and an obstacle during evasive maneuvers. Further, the vehicle 10 provides a minimal time-lag between an input steering angle and associated output lateral acceleration.

The vehicle 10 permits selection of a desired combination of front and rear wheel steering for maneuverability of the vehicle 10 that is optimal for particular criteria. For example, during an evasive action, the vehicle 10 may require lateral translation in the direction V_{y} in a short period of time. A conventional front wheel steer vehicle will rotate during such evasive action. Once a yaw speed \dot{ψ} is generated, this inertia may result in skidding or other lost control of the vehicle, particularly in situations with poor friction between tires and ground. Accordingly, the passenger vehicle 10 with front and rear steering may minimize the amount of yaw speed \dot{ψ} during evasive action.

There are other situations where vehicle performance can be optimized by making steering angle adjustments to the individual wheels 14L, 14R, 16L, 16R. An exemplary situation is when an external side wind is imparted upon the vehicle body 12. Under this circumstance, a compensating side force may be exerted upon the vehicle body 12 by individual steering of the wheels 14L, 14R, 16L, 16R in order to maintain the vehicle 10 in the driving direction Vₓ.

A truly parallel orientation of all wheels 14L, 14R, 16L, 16R may not always be optimal for a given situation and therefore individual steering angle adjustment for the wheels 14L, 14R, 16L, 16R may optimize steering for the given criteria. Additionally, during evasive action, there may be situations when a rotational translation of the vehicle 10 may be required for a combination of cornering and parallel translation of the vehicle 10. This decision may be based on the driver, or the vehicle 10.

There are also situations where stability is of less of a concern and convenience is of great concern. An example is during low speed maneuverability, such as parking. At low speeds the transverse forces applied to the wheels 14L, 14R, 16L, 16R are minimal and of little concern. During low speed turns, a greater rate of rotational translation \dot{ψ} relative to linear translation Vₓ, V_{y} is desired for optimizing convenience.

With reference now to FIG. 2, the vehicle 10 is illustrated in a front wheel steering mode, similar to that of conventional front wheel steering vehicles. The vehicle 10 is illustrated with the front wheels 14L, 14R each rotated about a vertical axis for steering of the vehicle 10. During the front wheel steer mode, large lateral forces are imparted upon the front wheels 14L, 14R in comparison to the lateral loads applied upon the rear wheels 16L, 16R. The magnitude of the lateral forces are illustrated by directional arrows in FIG. 2 upon each of the wheels 14L, 14R, 16L, 16R.

In FIG. 2, the vehicle 10 is illustrated in solid in a cornering position during the front wheel steering mode and relative to a prior position that is illustrated in phantom. During this cornering movement, the vehicle 10 translates linearly in a vector of directions Vₓ and V_{y}. and also the vehicle 10 translates rotationally generating a yaw speed \dot{ψ} about the vehicle's center of gravity. Such steering is optimal for changing direction of the vehicle 10, such as making turns. Front wheel steering of the vehicle 10 is similar to conventional front wheel steer vehicles. However, translation of the vehicle 10 from the first orientation in phantom to the second orientation illustrated in solid may not be optimal for parallel movement. During parallel movement, generation of the yaw speed \dot{ψ} generates a momentum about the center of gravity, which must be overcome in order to straighten out the vehicle. Although a front end of the vehicle 10 may clear an obstacle, the rear end may still impact the obstacle because the rear end of the vehicle 10 does not directly translate laterally with the front end of the vehicle 10.

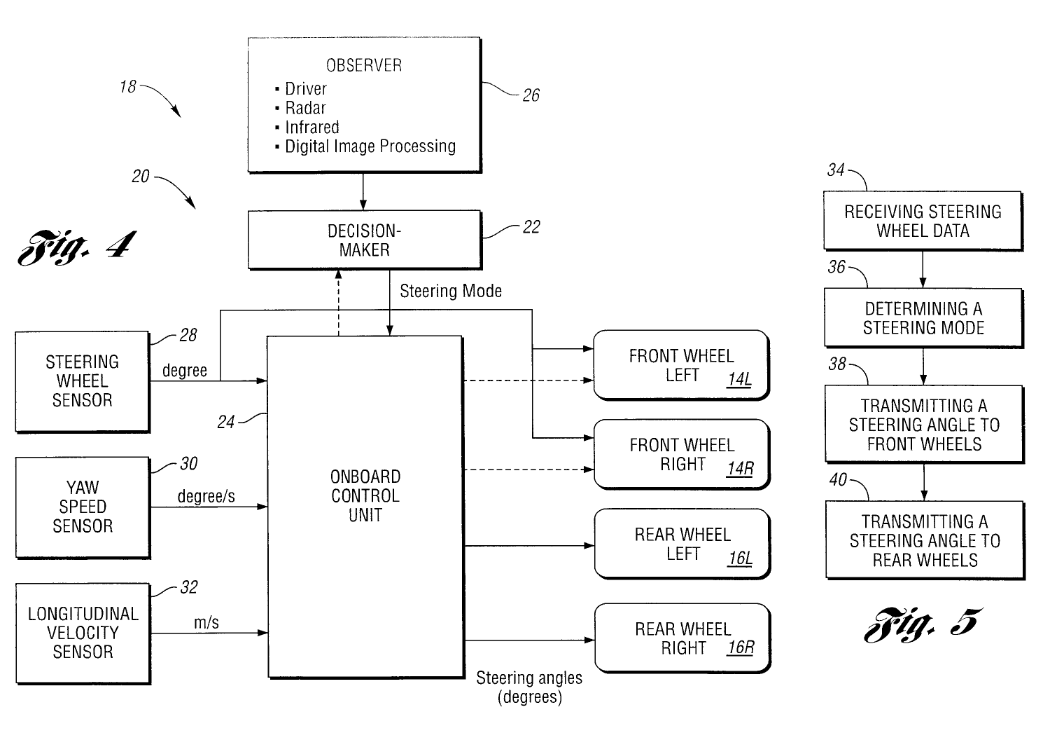

Accordingly, the vehicle 10 is also provided with an all wheel parallel steering mode as illustrated in FIG. 3. By applying steering to both the front wheels 14L, 14R and rear wheels 16L, 16R, steering angles for the front wheels 14L, 14R and the rear wheels 16L, 16R can be chosen in order to maximize lateral acceleration and minimize yaw speed \dot{ψ} of the vehicle 10. Further optimization may be provided by selecting a steering angle for each of the wheels 14L, 14R, 16L, 16R.

As illustrated in FIG. 3, the vehicle 10 may translate linearly with minimal or no rotational translation. Accordingly, the lateral forces imparted to the wheels 14L, 14R, 16L, 16R may be generally equal as indicated by the magnitude of the directional arrows in FIG. 3. The vehicle 10 may move a larger lateral distance than in the front wheel steering mode illustrated in FIG. 2. Thus, yaw speed \dot{ψ} can be minimized for maximizing stability and control of the vehicle 10 and minimizing occurrences such as skidding that may detract from the driver's control of the vehicle 10. Additionally, since the rear end of the vehicle 10 translates laterally along with the front end of the vehicle 10, the entire vehicle 10 may be steered to avoid an obstacle unlike the rear end of the vehicle 10 in the cornering steering mode illustrated in FIG. 2.

The steering angles of the rear wheels 16L, 16R may be similar to or the same as the angles of the front wheels 14L, 14R. However, by independent control of the rear wheels 16L, 16R, optimal angles may be provided to both the front wheels 14L, 14R and the rear wheels 16L, 16R. Additionally, each wheel 14L, 14R, 16L, 16R may be independently steered. Sensors may be provided within the vehicle 10 for measuring vehicle movement such as yaw speed, longitudinal velocity and acceleration, and steering angles for selecting optimal steering angles.

When the linear translation Vₓ, V_{y} is minimal and stability is of little concern, the independently steered rear wheels 16L, 16R may be steered in an opposite steering direction relative to the steering of the front wheels 14L, 14R for minimizing a turn radius of the vehicle 10. Thus, the vehicle 10 is also be provided with an all wheel, opposed steering mode.

With reference now to FIG. 4, a steering system 18 is illustrated for steering the front and rear wheels 14L, 14R, 16L, 16R of the vehicle 10. The steering system 18 includes a controller 20 with a decision-maker 22 for selecting the steering mode and an onboard control unit 24 for controlling the steering of the wheels 14L, 14R, 16L, 16R. The controller 20 may be provided by a single processor, or may be provided by individual processors for the decision-maker 22 and the onboard control unit 24.

The vehicle 10 or the driver determines what steering mode should be selected. In a front wheel steer mode, the selection of an all wheel steer mode may be required before a parallel steering movement or an opposed steering movement of the vehicle 10 can be made. Therefore, the controller 20 includes an observer 26 and the decision-maker 22 for selecting the steering mode in advance. The observer 26 may be the driver utilizing human senses and determining that parallel movement or opposed wheel movement is required. The vehicle 10 may utilize sensors such as radar, infrared technology, digital image processing or the like. Such vehicle sensors may identify a given probability that parallel movement or opposed steering movement is required.

If the driver is the observer 26, the driver can select the steering mode manually by manual actuation of a button, knob or the like provided within a passenger compartment of the vehicle 10. Accordingly, the driver, as the observer 26, may manually select the mode through the decision-maker 22.

Alternatively, the vehicle 10 may be the decision-maker 22 by receiving external data from the vehicle observer 26, related to positional data. Thus, the vehicle decision-maker 22 may select the steering mode. Once the steering mode is selected, the decision-maker 22 inputs the steering mode to the onboard control unit 24.

The steering system 18 may include sensors for sensing other input that may be processed by the onboard control unit 24. Accordingly, a steering wheel sensor 28 may be provided for measuring an angular orientation of a manual steering wheel and inputting the measurement in degrees to the onboard control unit 24. The onboard control unit 24 may utilize the angle of the steering wheel sensor 28 for determining a direction in which the driver intends to steer the vehicle 10.

Accordingly, the onboard control unit 24 may utilize the steering wheel sensor data for actuating the front wheels 14L, 14R in a front wheel steering mode, or actuate all four wheels 14L, 14R, 16L, 16R, in an all wheel steering mode. The onboard control unit 24 may send signals to each of the wheels 14L, 14R, 16L, 16R in a measurement of degrees for actuation of the wheels to the associated steering angles. The actuators for setting the steering angles could be electrical, hydraulic, pneumatic, mechanical or the like. Additionally, the steering of the front wheels 14L, 14R could be of a conventional type with a mechanical linkage with a steering wheel sensor 28 that directly drives the front wheels 14L, 14R as illustrated by the input arrows from the steering wheel sensor 28 to the front wheels 14L, 14R. In an embodiment with a front wheel steering conventional mechanical linkage, the rear wheels 16L, 16R may be actuated by actuators.

The invention also contemplates a common steering actuator for the rear wheels 16L, 16R. The steering angle for the rear wheels 16L, 16R could be similar or could be varied by mechanical, electrical, hydraulic or pneumatic controls.

A yaw speed sensor 30 may be provided in the steering system 18 for measuring and conveying yaw speed \dot{ψ} in degrees per second to the onboard control unit 24. A longitudinal velocity sensor 32 may be provided for measuring longitudinal velocity in meters per second and conveying this data to the onboard control unit 24. The onboard control unit 24 may analyze the data from the sensors 28, 30, 32 for providing optimal steering angles to each of the wheels 14L, 14R, 16L, 16R. The data may be analyzed for determining the steering angles based on efficiency, stability, safety or the like.

Additionally, the onboard control unit 24 may convey the data from the steering sensor 28, the yaw speed sensor 30 and the longitudinal velocity sensor 32 to the decision-maker 22. The decision-maker 22 may select the steering mode based on, for example, the steering wheel being turned slightly, such as within a narrow range, wherein large steering wheel angles are required for cornering, larger steering wheel angles are required for opposite steer cornering, and narrow steering angles are required for parallel movement.

Alternatively, the decision-maker 22 may make a steering mode determination based on the yaw speed \dot{ψ} from the yaw speed sensor 30 that stability is not being optimized, and the decision-maker 22 may select a parallel all wheel steering mode upon the yaw speed sensor 30 measuring a limit within a given range.

Additionally, the decision-maker 22 may determine the steering mode based upon a longitudinal velocity that is measured by the longitudinal velocity sensor 32. For example, the decision-maker 22 may determine that cornering will not occur at certain relatively high speeds and may select the steering mode of all wheel steering for high longitudinal velocities.

The invention also contemplates that the decision-maker 22 may override the driver's steering mode selection based on data received by the vehicle as the observer 26 or data provided by the steering wheel sensor 28, the yaw speed sensor 30 or the longitudinal velocity sensor 32.

The vehicle 10 as the observer 26 may observe external positioning data such as radar, infrared or digital image processing and may record and store such data within the onboard control unit 24 for subsequent access for evaluation of particular operations of the vehicle 10 and for analysis of recorded data after particular maneuvering has occurred.

With reference now to FIG. 5, a non-limiting method for the controller 20 is illustrated. In block 34, the controller 20 receives steering wheel data from the steering wheel sensor 28. In block 36, the controller 20 determines the steering mode, which is conveyed from the decision-maker 22 to the onboard control unit 24. In block 38, a steering angle is transmitted to the front wheels 14L, 14R for performing steering in front wheel and both all wheel steering modes. In block 40, the steering angle is transmitted to the rear wheels 16L, 16R.

In a front wheel steering mode, a steering angle of zero is imparted to the rear wheels 16L, 16R so that the steering is controlled by the front wheels 14L, 14R only. In an all wheel steering mode, non-zero steering angles are imparted to the rear wheels 16L, 16R for adjusting the steering angles of the rear wheels 16L, 16R similar or opposite to the front wheels 14L, 14R for permitting linear movements of the vehicle 10 with reduced rotational movements, such as the movement illustrated in FIG. 3, or for reducing the vehicle turning radius.

In summary, a passenger vehicle 10 is disclosed having a steering system 18 that utilizes front wheel and all wheel steering modes for optimizing translation and stability of the vehicle 10. Additionally, various methods are provided for controlling the steering system 18 of the present invention.

While embodiments for carrying out the invention have been described in detail, those familiar with the art to which this invention relates will recognize various alternative designs and embodiments for practicing the invention as defined by the following claims.

What is claimed:

1. A system for parallel steering of front wheels and rear wheels of a passenger vehicle comprising;
a steering mechanism mounted in a passenger vehicle for receiving manual rotation;
a sensor cooperating with the steering mechanism for measuring an angular orientation of the steering mechanism;
a controller in communication with the sensor for receiving an input from the sensor indicative of the steering mechanism angular orientation;
a front wheel steering actuator in communication with the controller for receiving a steering angle output from the controller for actuating the vehicle front wheels to a steering angle corresponding to the steering angle output; and
a rear wheel steering actuator in communication with the controller for receiving a steering angle output from the controller for actuating the vehicle rear wheels to a steering angle corresponding to the steering angle output for parallel steering of the vehicle, and for receiving a steering angle output from to controller for actuating the vehicle rear wheels to a forward direction for non-parallel steering of the vehicle.

2. The system of claim 1 further comprising a manual selector for selection of a parallel steering mode wherein the steering angle of the vehicle rear wheels corresponds to the vehicle front wheels steering angle and for selection of a non-parallel steering mode wherein the steering angle of the vehicle rear wheels are aligned with a forward direction of the vehicle.

3. The system of claim 1 further comprising a rotational velocity sensor for measuring rotational velocity of the vehicle, which is input to the controller for determining the steering angle output for the front wheels and the rear wheels.

4. The system of claim 1 further comprising a linear velocity sensor for measuring linear velocity of the vehicle, which is input to the controller for determining the steering angle output for the front wheels and the rear wheels.

5. The system of claim 1 further comprising a steering mode controller for selection of a parallel steering mode wherein the steering angle of the vehicle rear wheels corresponds to the vehicle front wheels steering angle and for selection of a non-parallel steering mode wherein the steering angle of the vehicle rear wheels are aligned with a forward direction of the vehicle.

6. The system of claim 5 further comprising radar equipment for measuring positional data of external obstacles, which is input to the steering mode controller for determining the steering mode.

7. The system of claim 5 further comprising infrared equipment for measuring positional data of external obstacles, which is input to the steering mode controller for determining the steering mode.

8. The system of claim 5 further comprising digital image processing equipment for measuring positional data of external obstacles, which is input to the steering mode controller for determining the steering mode.

9. A method for controlling parallel steering for a passenger vehicle with a vehicle controller comprising:
receiving a steering input from a manual steering mechanism;
receiving a steering mode input for selection of a front wheel steer mode or a parallel steer mode;
transmitting a steering angle output as a function of the steering input to steer front wheels of the vehicle; and
transmitting a steering angle output of zero to steer rear wheels in a direction of the vehicle in the front wheel steer mode or transmitting a steering angle output as a function of the steering input to steer the rear wheels in the parallel steer mode.

10. The method of claim 9 further comprising receiving the steering mode input from a manual steering mode selector.

11. The method of claim 9 further comprising receiving the steering mode input from a processor.

12. The method of claim 9 further comprising determining the steering mode from external data.

13. The method of claim 9 further comprising:
receiving manual steering mode selection data; and
determining the steering mode from the manual steering mode selection data.

14. The method of claim 9 further comprising:
receiving data corresponding to a rotational velocity of the vehicle; and
determining the front wheel and rear wheel steering angles from the vehicle rotational velocity data.

15. The method of claim 9 further comprising:
receiving data corresponding to a linear velocity of the vehicle; and
determining the front wheel and rear wheel steering angles from the vehicle linear velocity data.

16. The method of claim 9 further comprising:
receiving visual data; and
storing the visual data for subsequent viewing.

17. The method of claim 9 further comprising:
receiving radar data; and
determining the steering mode from the radar data.

18. The method of claim 9 further comprising:
receiving infrared positional data; and
determining the steering mode from the infrared positional data.

19. The method of claim 9 further comprising:
receiving visual data; and
determining the steering mode from the visual data.

20. A parallel steering passenger vehicle comprising:
a vehicle having a forward direction of travel and a passenger compartment;
a first pair of wheels operably connected to the vehicle for supporting the vehicle upon an underlying support surface and transporting the vehicle upon the support surface, the first pair of wheels each being pivotal about a vertical axis for steering the vehicle as the vehicle travels;
a second pair of wheels operably connected to the vehicle spaced apart from the first pair of wheels in the direction of travel, for supporting the vehicle upon the underlying support surface and transporting the vehicle upon the support surface, the second pair of wheels each being pivotal about a vertical axis for steering the vehicle as the vehicle is transported;
a steering mechanism mounted for manual rotation within the passenger compartment, the steering mechanism being in operable communication with the first pair of wheels for actuating the first pair of wheels to a steering angle as a function of an angular orientation of the steering mechanism, the steering mechanism being in selectively operable communication with the second pair of wheels for actuating the second pair of wheels to a steering angle as a function of the angular orientation of the steering mechanism; and
a controller in operable communication with the second pair of wheels for selecting a first steering mode wherein the second pair of wheels are each aligned generally parallel with the forward direction of travel so that the vehicle can translate linearly and rotationally as a function of the first set of wheels controlled by the steering mechanism, and a second steering mode wherein the second pair of wheels are each aligned generally parallel with a corresponding orientation of one of the first set of wheels so that the vehicle can translate linearly with reduced rotational translation.
